(19) United States
(12) Patent Application Publication
(10) Pub. No.: US 2007/0111656 A1
(43) Pub. Date: May 17, 2007

(54) ELECTRONIC DEVICE HAVING MOVABLE AND ROTATABLE UPPER AND LOWER HOUSINGS

(76) Inventor: Hsien-Ju Hsieh, Chi-Lung City (TW)

Correspondence Address: NORTH AMERICA INTELLECTUAL PROPERTY CORPORATION, P.O. BOX 506, MERRIFIELD, VA, 22116, US

(21) Appl. No.: 11/558,467

(22) Filed: Nov. 10, 2006

(30) Foreign Application Priority Data
Nov. 17, 2005 (TW) 094140498

(51) Int. Cl. H04H 9/00

(52) U.S. Cl. 455/2.01

(57) ABSTRACT

An electronic device includes an upper housing, a lower housing, an elastic element, and a connecting device. The upper housing includes a latching device and a groove. The lower housing includes a latching device for fastening the latching device of the upper housing. A plate portion of the connecting device is inserted into the groove of the upper housing, and a circular component portion of the connecting device is connected to the lower housing of the electronic device in a rotatable manner. A first end of the elastic element is connected to the lower housing of the electronic device, and a second end of the elastic element is connected to the circular component portion of the connecting device.

### BACKGROUND OF THE INVENTION

1. Field of the Invention

The present invention relates to an electronic device having movable and rotatable upper and lower housings, and more particularly, to a foldable cellular phone having movable and rotatable upper and lower housings.

2. Description of the Prior Art

With rapid development of technology, communication systems have greatly progressed and convenient small-sized electronic devices have been widely used in daily life. With these versatile electronic devices, people can exchange information, share experiences and communicate with others almost anywhere and anytime. Aside from the functionality, the price of the product is also a major factor when the user decides what to purchase from the vast variety of communication electronic devices. Many communication electronic devices commonly available in the consumer market include an upper housing and a lower housing, such as foldable cellular phones. The upper housing of a conventional foldable cellular phone includes a display panel, and the lower housing of the foldable cellular phone includes a control panel. The upper and lower housings of the foldable cellular phone, folded in standby mode, have to be unfolded for receiving incoming calls, transmitting data or performing short message service (SMS).

FIG. 1 shows a diagram of a prior art foldable cellular phone 10. The foldable cellular phone 10 includes an upper housing 12, a lower housing 14, and a hinge 16 via which the upper housing 12 and the lower housing 14 are connected. The hinge 16 controls the movement of the upper housing 12 and the lower housing 14. A user can open the foldable cellular phone 10 with the upper housing 12 and the lower housing 14 folded by providing a force in a direction indicated by an arrow shown in FIG. 1. When the angle between the upper housing 12 and the lower housing 14 becomes larger than an angle θ, the hinge 16 takes over and provides subsequent force required for opening the upper housing 12 and the lower housing 14. Similarly, the user closes the foldable cellular phone 10 by providing a force opposite to the direction indicated by the arrow shown in FIG. 1. When the angle between the upper housing 12 and the lower housing 14 becomes smaller than the angle θ, the hinge 16 takes over and provides subsequent force required for closing the upper housing 12 and the lower housing 14.

In the prior art foldable cellular phone 10, the hinge 16 is used for controlling the movement of the upper housing 12 and the lower housing 14, so that the upper housing 12 and the lower housing 14 can be folded or unfolded in a rotatable manner. However, the hinge 16 is very expensive and raises the manufacturing cost of the foldable cellular phone 10, thus making the foldable cellular phone 10 less competitive.

### SUMMARY OF THE INVENTION

The claimed invention provides an electronic device having movable and rotatable upper and lower housings comprising an upper housing including a first latching device and a groove; a lower housing including a second latching device for engaging with the first latching device; a connecting device having a plate portion disposed in the groove of the upper housing in a movable manner; and a circular component portion connected to the plate portion and having two ends connected to the lower housing in a rotatable manner; and a first elastic element having a first end connected to the lower housing and a second end connected to the circular component portion of the connecting device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a diagram of a prior art foldable cellular phone.

FIG. 2 shows an explosive diagram of a foldable cellular phone according to the present invention.

FIG. 3 shows an enlarged diagram of the connecting device in FIG. 2.

FIG. 4 shows a diagram of the connecting device and the lower housing in connection with each other.

FIG. 5 shows an enlarged diagram of the foldable cellular phone according to the present invention.

FIGS. 6 and 7 are diagrams illustrating the movement between the upper housing and the lower housing of the foldable cellular phone according to the present invention.

FIGS. 8 and 9 are enlarged diagrams of the latching devices according to the present invention.

FIGS. 10-13 are diagrams illustrating methods of folding and unfolding the foldable cellular phone according to the present invention.

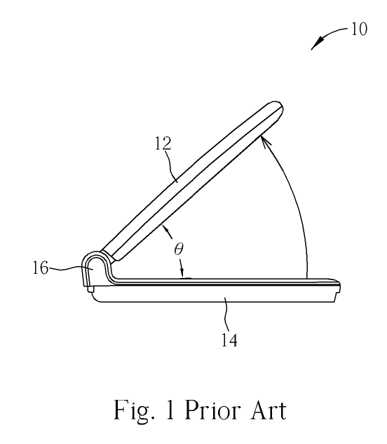

### DETAILED DESCRIPTION

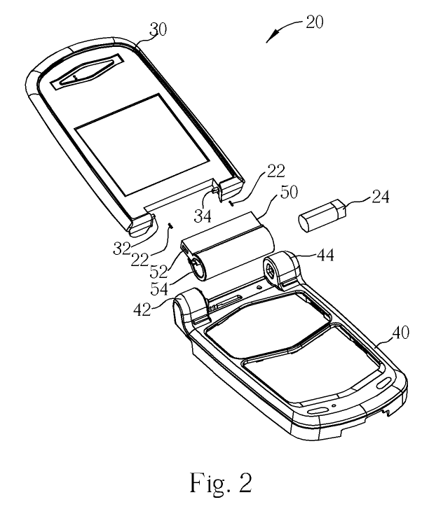

FIG. 2 shows an explosive diagram of a foldable cellular phone 20 according to the present invention. The foldable cellular phone 20 includes an upper housing 30, a lower housing 40, a connecting device 50, and elastic elements 22, 24. The upper housing 30, in which a display panel can be disposed, includes protrusions 32, 34. The lower housing 40, in which a control panel can be disposed, includes protrusions 42, 44. The connecting device 50 includes a plate portion 52 and a circular component portion 54. The plate portion 52 can be connected to the protrusions 32 and 34 of the upper housing 30 via the elastic element 22. One end of the circular component portion 54 can be connected to the protrusion 44 of the lower housing 40 via the elastic element 24. The methods with which the upper housing 30 and the lower housing 40 are connected to the elastic elements 22, 24 will be described in more detail later.

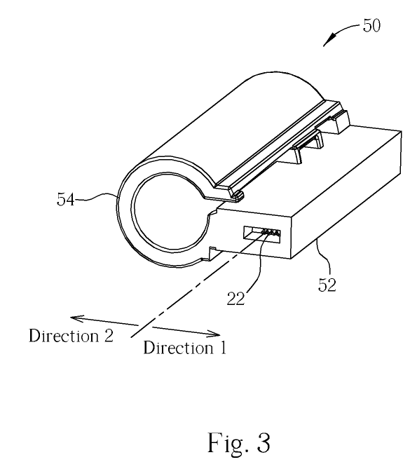

FIG. 3 shows an enlarged diagram of the connecting device 50 in FIG. 2. The connecting device 50 includes the plate portion 52 and the circular component portion 54. One end of an elastic element 22 is attached to one side of a slot located a first end of the plate portion 52, while the other end of the elastic element 22 is connected to the protrusion 42 of the lower housing 40 (as shown in FIG. 3). Similarly, one end of an elastic element 22 is attached to one side of a slot located a second end of the plate portion 52, while the other end of the elastic element 22 is connected to the protrusion 44 of the lower housing 40 (not shown in FIG. 3). Therefore, the upper housing 30 and the connecting device 50 can be connected via two elastic elements 22. The elastic elements 22 can include springs, whose natural force works in a direction 2 represented by an arrow in FIG. 3. When a force is applied externally in a direction 1 represented by an arrow in FIG. 3, the natural force of the elastic element 22 provides a reverse force in the opposite direction (the direction 2).

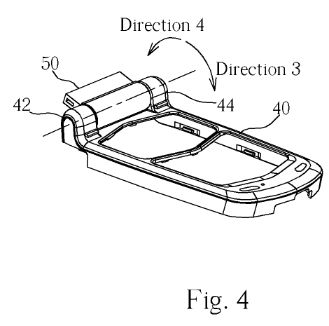

FIG. 4 shows a diagram of the connecting device 50 and the lower housing 30 in connection with each other. The circular component portion 54 of the connecting device 50 includes a hollow structure. One end of the circular component portion 54 is disposed in a concave cavity in the protrusion 42 of the lower housing 40, and can move in a rotatable manner. The other end of the circular component portion 54 is connected to a concave cavity in the protrusion 44 of the lower housing 40 via the elastic element 24, and can move in a rotatable manner. Since the elastic element 24 is disposed in the hollow structure of the circular component portion 54 and the concave cavity of the protrusion 44, the elastic element 24 is not shown in FIG. 4. The elastic element 24 can include a torsional spring, whose natural force works in a direction 4 represented by an arrow in FIG. 4. When a force is applied externally in a direction 3 represented by an arrow in FIG. 3, the natural force of the elastic element 24 provides a reverse force in the opposite direction (the direction 4). When no force is applied externally, the natural force of the elastic element 24 provides a force in the direction 4 so that the lower housing 40 and the connecting device 50 remain unfolded with an angle, as shown in FIG. 4.

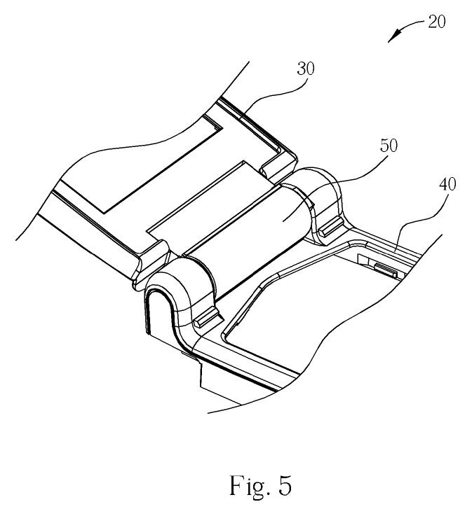

FIG. 5 shows an enlarged diagram of the devices of the foldable cellular phone 20 at the connecting location. The upper housing 30 and the connecting device 50 can move towards or away from each other in a linear direction, as illustrated in FIG. 3. The lower housing 40 and the plate portion 52 of the connecting device 50 can move toward or away from each other in a rotatable manner, as illustrated in FIG. 4. When no force is applied externally, the natural force of the elastic elements 22, 24 opens the upper housing 30 and the lower housing 40 so that the surfaces of the upper housing 30 and the lower housing 40 are disposed at a certain angle, as shown in FIG. 5.

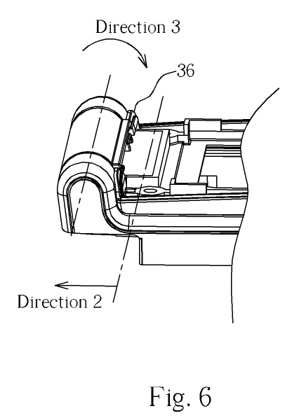

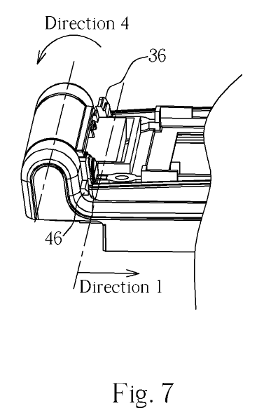

FIGS. 6 and 7 illustrate the movement between the upper housing 30 and the lower housing 40 of the foldable cellular phone 20. The upper housing 30 and the lower housing 40 further includes latching devices 36, 46, respectively. When a user applies a force in the direction 3, the upper housing 30 and the lower housing 40 can be moved closer to each other. However, once the external force is removed, the upper housing 30 and the lower housing 40 will be pushed away from each other by the natural force of the elastic element 24 working in the direction 4. Therefore, the latching devices 36, 46 are required for fastening the upper housing 30 and the lower housing 40. When the upper housing 30 and the lower housing 40 are in contact with each other due to a force applied by the user in the direction 3, the natural force of the elastic element 22 applies a force in the direction 2, thereby connecting the latching devices 36, 46 to each other, as shown in FIG. 6. Since the latching devices 36, 46 are connected to each other, the latching device 46 of the lower housing 40 is not shown in FIG. 6. In FIG. 7, the user can open the upper housing 30 and the lower housing 40 of the foldable cellular phone 20 by applying a force in the direction 1, thereby separating the latching devices 36, 46 from each other. Subsequently, the natural force of the elastic element 24 applies a force in the direction 4, thereby pushing the upper housing 30 and the lower housing 40 away from each other. Because the latching devices 36, 46 are separated from each other, the latching device 46 of the lower housing 40 is clearly shown in FIG. 7. The latching device 36 can include a hook, and the latching device 46 can include a slot. Or, the latching device 36 can include a slot, and the latching device 46 can include a hook.

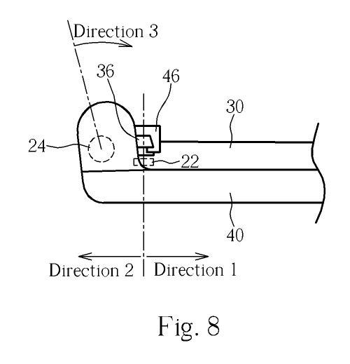

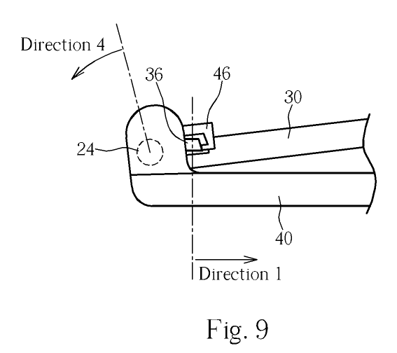

FIGS. 8 and 9 are enlarged diagrams of the latching devices 36, 46. As mentioned before, the latching devices 36, 46 can have different structures. In the embodiments shown in FIGS. 8 and 9, the latching device 36 forms a slot with the lower housing 40, and the latching device 46 includes a hook. The latching device 36 has an inclined plane, along which a hook-shaped end of the latching device 36 can slide downwards when a force is applied in the direction 3. When the upper housing 30 and the lower housing 40 are in contact with each other, the natural force of the elastic element 22 applies a force in the direction 2 so that the hook-shaped end of the latching device 46 is pushed under the bottom of the latching device 36. Therefore, the latching devices 36, 46 are latched and the upper housing 30 and the lower housing 40 can remain folded. Similarly, the hook-shaped end of the latching device 46 can be separated from the bottom of the latching device 36 by applying a force in the direction 1. Once the hook-shaped end of the latching device 46 is no longer in contact with the bottom of the latching device 36, the natural force of the elastic element 24 applies a force in the direction 4 for separating the upper housing 30 from the lower housing 40. At this time, the hook-shaped end of the latching device 46 slides upwards along the inclined plane of the latching device 36 until the upper housing 30 and the lower housing 40 are unfolded.

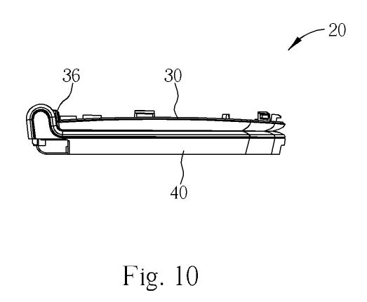

FIGS. 10-13 are diagrams illustrating methods of folding and unfolding the foldable cellular phone 20. The method of folding the foldable cellular phone 20 according to the present invention includes the following steps and can be depicted using FIGS. 10-13 sequentially:

Step 1: apply a force in a direction opposite to the natural force of the elastic element 22 for separating the latching devices 36, 46; and

Step 2: separating the upper housing 30 from the lower housing 40 in a rotatable manner using the natural force of the elastic element 24.

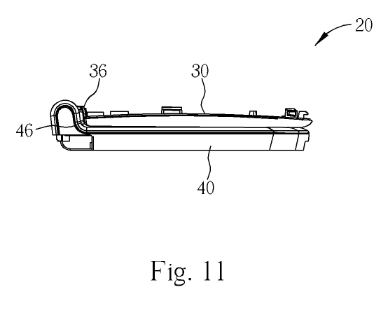

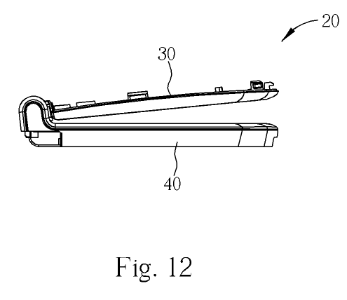

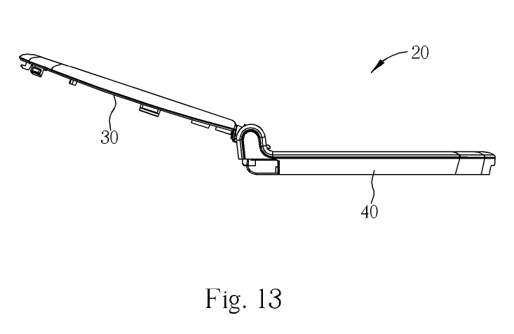

The foldable cellular phone 20 shown in FIG. 10 is folded. After separating the latching devices 36, 46 from each other in step 1, the foldable cellular phone 20 is shown in FIG. 11. When the natural force of the elastic element 24 begins to separate the upper housing 30 from the lower housing 40 in a rotatable manner, the foldable cellular phone 20 is shown in FIG. 12. After the steps 1 and 2 are completed, the foldable cellular phone 20 is shown in FIG. 13.

The method of unfolding the foldable cellular phone 20 according to the present invention includes the following steps and can be depicted using FIGS. 13-10 sequentially:

Step 3: apply a force in a direction opposite to the natural force of the elastic element 24 for moving the upper housing 30 and the lower housing 40 towards each other in a rotatable manner; and

Step 4: connecting the latching devices 36 and 46 using the natural force of the elastic element 22 for connecting the upper housing 30 and the lower housing 40 with each other.

The foldable cellular phone 20 shown in FIG. 13 is unfolded. In step 3, the upper housing 30 and the lower housing 40 are moved towards each other in a rotatable manner (as shown in FIG. 12), and finally in contact with each other (as shown in FIG. 11). In FIG. 10, the latching devices 36, 46 are connected by the natural force of the elastic element 22 and the foldable cellular phone 20 is folded, as shown in FIG. 10.

In the foldable cellular phone 20 of the present invention, the elastic elements 22, 24 and the connecting device 50 are used for controlling the movement of the upper housing 30 and the lower housing 40, so that the upper housing 30 and the lower housing 40 can be folded and unfolded in linear and rotatable manners. Compared to the expensive hinge 16 used in the prior art foldable cellular phone 10, the elastic elements 22, 24 used in the present invention are inexpensive and simple. Therefore, the present invention can reduce the manufacturing cost and increase compatibility of foldable cellular phones.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device having movable and rotatable upper and lower housings comprising:
an upper housing including a first latching device and a groove;
a lower housing including a second latching device for engaging with the first latching device;
a connecting device having:
a plate portion disposed in the groove of the upper housing in a movable manner; and
a circular component portion connected to the plate portion and having two ends connected to the lower housing in a rotatable manner; and
a first elastic element having a first end connected to the lower housing and a second end connected to the circular component portion of the connecting device.

2. The electronic device of claim 1 wherein the first elastic element includes a torsional spring.

3. The electronic device of claim 1 further comprising a second elastic element having a first end connected to a protrusion of the groove of the upper housing and a second end connected to the plate portion of the connecting device.

4. The electronic device of claim 3 wherein the second elastic element includes a torsional spring.

5. The electronic device of claim 1 wherein the first latching device includes a hook, and the second latching device includes a slot.

6. The electronic device of claim 5 wherein the hook has an inclined plane.

7. The electronic device of claim 5 wherein the slot has an inclined plane.

8. The electronic device of claim 1 wherein the second latching device includes a hook, and the first latching device includes a slot.

9. The electronic device of claim 8 wherein the hook has an inclined plane.

10. The electronic device of claim 8 wherein the slot has an inclined plane.

11. The electronic device of claim 1 being a foldable cellular phone.

12. The electronic device of claim 1 wherein the upper housing includes a display panel and the lower housing includes a control panel.
